(19) United States
(12) Patent Application Publication
(10) Pub. No.: US 2013/0213271 A1
(43) Pub. Date: Aug. 22, 2013

(54) CEMENT HYDRATE COMPOSITIONS AND METHODS OF SYNTHESIS

(71) Applicant: Massachusetts Institute of Technology, (US)

(72) Inventors: Shahsavari Rouzbeh, Houston, TX (US); Pellenq J.M. Roland, Belmont, MA (US); Stewart Lynn Karen, Watertown, MA (US); Van Vliet J. Krystyn, Waltham, MA (US); Yip Sidney, Cambridge, MA (US); Ulm Franz-Josef, Cambridge, MA (US)

(73) Assignee: Massachusetts Institute of Technology, Cambridge, MA (US)

(21) Appl. No.: 13/762,082

(22) Filed: Feb. 7, 2013

Related U.S. Application Data
(60) Provisional application No. 61/633,228, filed on Feb. 7, 2012.

(51) Int. Cl. C04B 7/00

(52) U.S. Cl. CPC C04B 7/00
USPC 106/600

(57) ABSTRACT

Cementitious compositions and methods of synthesis are disclosed. By decreasing the Ca-rich raw material in a cement composition, the content of Alite (Ca₃SiO₅) per ton of produced cement can be mitigated. Alite is the most energy-intensive and most polluting component among cement ingredients. By decreasing this component, the process can potentially reduce the environmental footprint and energy consumption by as much as 12% per ton of cement. In one embodiment, the average Ca/Si ratio in hardened cement paste can be reduced from ˜1.7 to ˜1.5. This corresponds to about a 12% reduction in Alite content per ton of produced cement. The cement compositions can also be characterized as solid-state cement hydrates including a plurality of silicate chains, the plurality of silicate chains including a plurality of dimers constituting at least about 60% of the plurality of silicate chains present in the solid-state cement hydrate, the plurality of dimers enhancing the strength of the solid-state cement hydrate. Such solid-state cement hydrates can also exhibit a periodic molecular structure formed from the plurality of silicate chains, e.g., ring-like structures.

### RELATED APPLICATIONS

This application claims the benefit of priority to U.S. Provisional App. No. 61/633,228, filed on Feb. 7, 2012, which is herein incorporated by reference in its entirety.

### FIELD

The invention generally relates to cement compositions and methods for producing such compositions.

### BACKGROUND

Concrete is the most widely used manufacturing material on the planet. The current worldwide concrete production stands at more than 20 billion tons, enough to produce more than one cubic meter of concrete per capita per year. Concrete is generally manufactured locally and on demand by mixing cement powder with water and an aggregate such as stone or sand. Cement is the key strengthening ingredient in concrete, the production of which expends a considerable amount of energy and contributes to 5-10% of CO₂ emissions and significant levels of harmful NOₓ worldwide. The heavy ecological price required to produce cement makes concrete the greatest climate change culprit outside of transportation and the generation of electricity. Amazingly, though concrete has been in widespread use since the Roman Empire and is the focus of a multibillion-dollar industry that is under pressure to be more eco-friendly, cement and concrete manufacturing processes remain largely reliant on methods of manufacture developed in the nineteenth century.

Accordingly, there exists a need for cementitious compositions and methods for producing the same that exhibit a smaller ecological footprint, while maintaining or improving the strength and/or other material characteristics that have made concrete essential to modern physical infrastructure.

### SUMMARY OF INVENTION

The present teachings relate to a cement product that can significantly diminish the ecological impact of cement production and use. In various aspects, nanoengineered cement compositions in accordance with the present teachings can result in greater strength of the cement, as well as lower energy consumption and reduced CO₂ and NOₓ emissions.

In one aspect of the present teachings, it has been discovered that the use of Ca-rich raw materials such as Alite (Ca₃SiO₅), the most energy-intensive and polluting component among cement ingredients, can be reduced without reducing strength of the cement. By decreasing the amount of Alite in the produced cement, processes in accord with the present teachings can potentially reduce the environmental footprint and energy consumption by as much as 12% per ton of cement. In one embodiment, the average Ca/Si ratio (CaO:SiO₂) in the calcium-silicate-hydrate (C-S-H) of hardened cement paste can be reduced from ˜1.7 (typical of prior commercial cements) to ˜1.5. This corresponds to about a 12% reduction in Alite content per ton of produced cement.

Moreover, increasing the average strength of the cement (and ultimately the strength of concrete produced therefrom) could lead to more efficient use of the cementitious compositions in smaller quantities. By way of example, an increase in the strength of cement a factor of δ would result in a reduction of energy consumption, and hence the environmental footprint, by (δ−1)/δ. Whereas strength increases could traditionally only be achieved with more material (i.e., higher energy, larger environmental footprint), various aspects of the present teachings provide a re-engineered elementary building block based on atomistic modeling that can result in improved material characteristics such as increased density and/or strength relative to cement pastes known in the art.

In another aspect of the invention, cementitious compositions with enhanced strength are disclosed that can be characterized as solid-state cement hydrates including a plurality of silicate chains, the plurality of silicate chains including a plurality of dimers constituting at least about 60% of the plurality of silicate chains present in the solid-state cement hydrate, the plurality of dimers enhancing the strength of the solid-state cement hydrate. In some embodiments, the dimeric chains can more than 70%, 80%, 90% or even 95% of the silicate chains. Such solid-state cement hydrates can also exhibit a periodic molecular structure formed from the plurality of silicate chains, e.g., ring-like structures.

In a further aspect of the invention, cementitious compositions with enhanced strength are disclosed and characterized as solid-state cement hydrates including a plurality of silicate chains, the solid-state cement hydrate exhibiting a periodic molecular structure formed from the plurality of silicate chains, the periodic molecular structure enhancing the strength of the solid-state cement hydrate. The term “periodic” as used herein is intended to encompass organized molecular structures that may be repeated but need not extend throughout the composition. That is to say, “periodic” is not meant to imply a single homogeneous lattice or a crystalline material. The plurality of silicate chains can include a plurality of dimers and the periodic molecular structure can comprise ring-like structures in a plane substantially perpendicular to a Wollastonite layer of the solid-state cement hydrate.

In yet another aspect of the invention, cementitious compositions with enhanced strength are disclosed and characterized as solid-state cement hydrates including a plurality of silicate chains, the solid state cement hydrate exhibiting a CaO to SiO₂ ratio less than 1.7 and, in some instances preferably between about 1.4 and about 1.6 (as measured at an early stage in the formation, e.g., about 30 days or less following hardening.) In one embodiment, such solid-state cement hydrates exhibit a density greater than 2.61 g/cm³.

The cementitious compositions of the present invention are particularly useful in concrete materials.

Methods for producing the cementitious compositions are also disclosed and can include the steps of: reducing an amount of limestone utilized to form the cementitious composition to decrease an amount of Alite formed as a portion of an intermediate material; and reducing an amount of energy needed to transform the intermediate material into the cementitious composition.

### BRIEF DESCRIPTION OF DRAWINGS

The file of this patent contains at least one photograph or drawing executed in color. Copies of this patent with color drawing(s) or photograph(s) will be provided by the Patent and Trademark Office upon request and payment of the necessary fee.

The skilled person in the art will understand that the drawings, described below, are for illustration purposes only and are not intended to limit the scope of the applicants' teachings.

FIG. 1A-1D illustrate various silica chains typically found in C-S-H of hardened cement pastes;

FIG. 2 illustrates local values of Ca/Si characteristic within the C-S-H of prior cement pastes;

FIG. 3 illustrates exemplary local values of Ca/Si within a C-S-H according to various aspects of the present teachings;

FIG. 4 illustrates schematically an exemplary C-S-H according to various aspects of the present teachings;

FIG. 5 illustrates schematically a top view of the exemplary C-S-H depicted in FIG. 4;

FIG. 6 illustrates a side view of the exemplary C-S-H depicted in FIG. 4;

FIG. 7 illustrates the silicate dimers of the exemplary C-S-H depicted in FIG. 4.

FIG. 8 depicts the density and interlayer spacing for various exemplary C-S-H generated using atomistic simulations;

FIG. 9 depicts indentation and elastic modulus simulated and experimental data for the various exemplary atomistic C-S-H depicted in FIG. 8 and experimental cement pastes; and

FIG. 10 depicts the simulated cell height as a function of dimer content and bulk elastic modulus as a function of density from the various exemplary C-S-H depicted in FIG. 8.

### DETAILED DESCRIPTION

The following detailed description should be read with reference to the drawings. The drawings, which are not necessarily to scale, depict selected embodiments and are not intended to limit the scope of the invention. The detailed description also illustrates by way of example, and is not intended to limit the scope of the invention. It will be apparent that the described embodiments may be susceptible to alteration or variation according to common general knowledge without departing from the scope of the disclosure. The following detailed description of embodiments is not to be regarded as limiting the scope of the applicants' teachings in any manner.

The teachings herein generally provide calcium-silicate-hydrates (C-S-H) having improved material properties and/or exhibiting reduced environmental impact relative to cement pastes known in the art. The principal source of strength and durability in concrete and all cement-based materials is C-S-H, which is the main component in cement hydrate—the paste that forms and quickly hardens when cement powder is mixed with water. C-S-H is considered to be the smallest basic building block of concrete and has a complex nanostructure which has eluded many scientific attempts over the last few decades to understand and improve its mechanical properties. In accordance with various aspects of the present teachings the average Ca/Si ratio in hardened cement paste can be reduced from ˜1.7 to ˜1.5, with at least about 60% of the silicate chains of the C-S-H phase being silicate dimers.

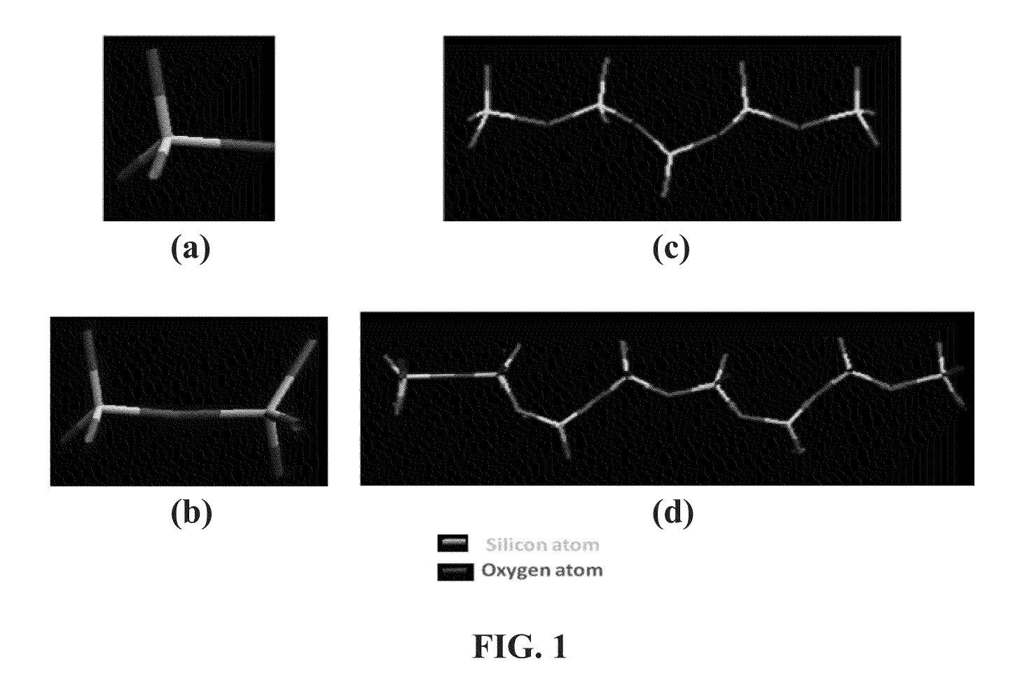

As used herein, the term “silicate chain” refers to chains of connected silicon tetrahedra in cement hydrates or other cementitious materials, the chains generally containing silicon (Si) and oxygen (O) atoms in the various forms depicted in FIG. 1. It will additionally be appreciated by a person skilled in the art that in some cement hydrates, the silicon atoms can be replaced by aluminum (Al) atoms, though the occurrence of such situations is relatively rare.

With specific reference first to FIG. 1(a), a silicate monomer is depicted. As shown, a silicate monomer refers to a single silicon tetrahedron in which one silicon atom is connected to four oxygen atoms. As shown in FIG. 1(b), a silicate dimer refers to two connected silicon tetrahedra in which two silicon atoms are connected to seven oxygen atoms. A person skilled in the art will further appreciate that any number of silicon tetrahedra can be connected to result in the higher order silicate chains typical of hardened cement hydrates, for example, in the silicate pentamer depicted in FIG. 1(c) (five Si atoms connected to 16 O atoms) and the silicate octamer depicted in FIG. 1(d) (eight Si atoms connected to 25 O atoms).

While prior cement hydrates can be characterized as an amorphous material having a mix of the monomers, dimers, pentamers, octamers (and even longer silicate chains) distributed therethrough in random locations, for example, cementitious compositions in accord with the present teachings generally exhibit a C-S-H in which silicate dimers make up the majority of the silicate chains in the cement hydrate. Accordingly, as derived from computational material design and validated with experiments, cement hydrates that include a majority of dimers in accordance with various aspects of the present teachings can exhibit a well-defined atomistic composition and structure with maximum stiffness and strength.

By way of example, in an exemplary embodiment of the present teachings, the average chemical formula and density of the C-S-H can be about (CaO)_{1.5}(SiO₂)(H₂O)_{1.39} and 2.635 g/cm³. That is, in accordance with various aspects of the present teachings, the Ca/Si ratio of the hardened cement hydrate can be about 1.5. By way of comparison, neutron scattering experiments have recently determined that the average chemical properties of known C-S-H are (CaO)_{1.7}(SiO₂)(H₂O)_{1.8} and 2.604 g/cm³. See Allen A J et al., “Composition and density of nanoscale calcium-silicate-hydrate in cement,” Nat Mater 6:311-316 (2007). Similarly, a recent realistic molecular modeling approach determined that the average chemical properties of known C-S-H are (CaO)_{1.65}(SiO₂)(H₂O)_{1.75} and 2.56 g/cm³. See Pellenq R. et al., “A realistic molecular model for cement hydrate,” Proc Nat Acad Scie US 106, 16102 (2009). It will thus be appreciated that cementitious compositions known in the art exhibit typical Ca/Si ratios of about 1.7.

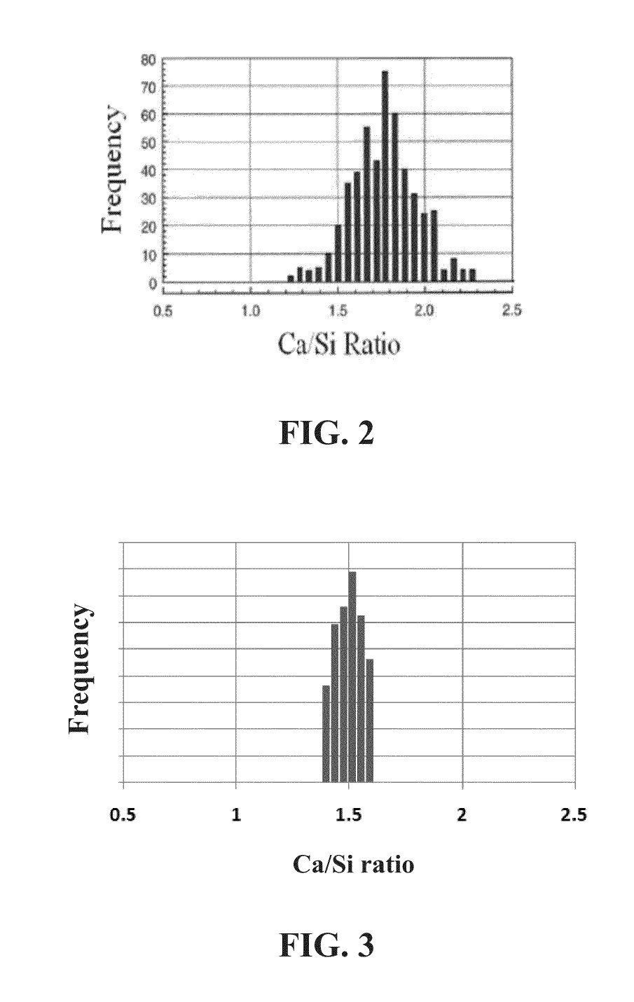

Moreover, exemplary C-S-H in accordance with various aspects of the present teachings not only exhibit a reduced Ca/Si ratio relative to cement hydrates typically used in the art but also exhibit a more uniform local ratio of Ca/Si throughout the cementitious composition. With reference now to FIG. 2, recent studies have demonstrated that the ratio of Ca/Si in known C-S-H typically varies widely between discrete locations in the cement hydrate. As shown in FIG. 2, for example, local values for the Ca/Si ratio in known C-S-H exhibits a broad spectrum with a mean at 1.7. See Groves G W et al. “Transmission electron microscopy and microanalytical studies of ion-beam-thinned sections of tricalcium silicate paste,” J Am Ceram Soc 69:353-356 (1986) and Richardson I G et al., “The microstructure and microanalysis of hardened cement pastes involving ground granulated blast-furnace slag,” J Mater Sci 27:6204-6212 (1992).

However, with reference now to FIG. 3, exemplary C-S-H in accordance with the present teachings can exhibit increased uniformity. By way of example, local values of Ca/Si exhibit a much narrower spectrum relative to that of prior C-S-H, with a reduced mean at about 1.5. In various aspects and without being bound to any particular theory, it is believed that the increased uniformity can be attributed to the major presence of silicate dimers (i.e., FIG. 1(a)) that promote a relatively ordered structures, decreased layer spacing, and increased density as discussed in further detail below. By way of example, in various aspects of the present teachings, silicate dimers can constitute at least about 50% or even more of the plurality of silicate chains present in the hardened cement hydrate. For example, the silicate dimers can constitute at least about 60% of the plurality of silicate chains present in the hardened (e.g., solid-state), and in some aspects more than 70%, 80%, 90% and even 95% of the silicate chains. With specific reference to FIG. 3, for example, about 80% of the Si atoms in the exemplary C-S-H are in the form of a silicate dimer, with the remaining 20% in the form of monomers, pentamers, octamers, etc.

The ordered structure of the C-S-H according to the present teachings not only results in increased uniformity of chemical and material properties (e.g., Ca/Si ratio) throughout the hardened cement hydrate, but can additionally enable the formation of cementitious compositions that exhibit increased density, decreased CaO, and/or decreased water content compared to that generally found in prior C-S-H.

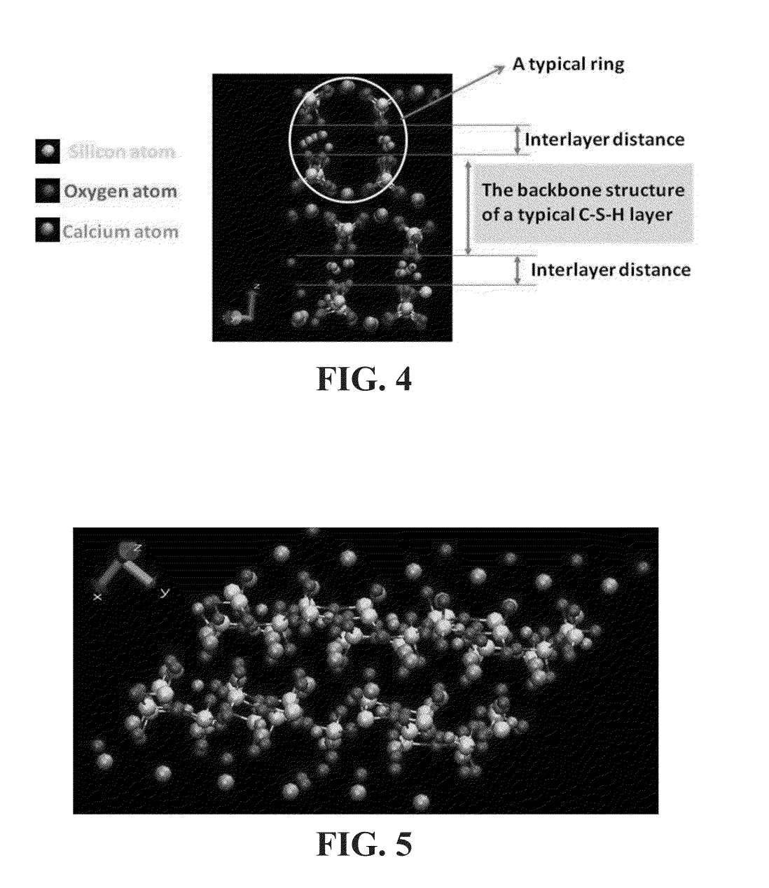

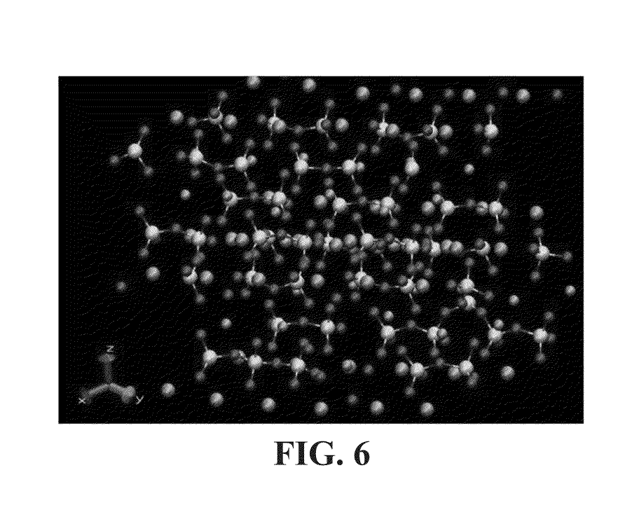

With reference now to FIGS. 4-7, these figures, using a combinatorial approach in conjunction with atomistic modeling, schematically depict an exemplary C- S-H according to various aspects of the present teachings. FIG. 4, for example, depicts an exemplary unit cell of C-S-H having periodic boundary conditions and that can be repeated in the x-, y- and z-directions. The exemplary view depicted in FIG. 4 is perpendicular to the direction of layers (“Wollastonite layers” in crystalline C-S-H minerals) and illustrates that the backbone layer includes Si, Ca and O atoms in well-defined arrangements, and which form a ring in conjunction with the adjacent upper or lower layers. These rings become hosts for trapping part of water molecules. For the purpose of clarity, the trapped water molecules are not shown. FIGS. 5 and 6 depict the C-S-H structure of FIG. 4 in top and side view, respectively.

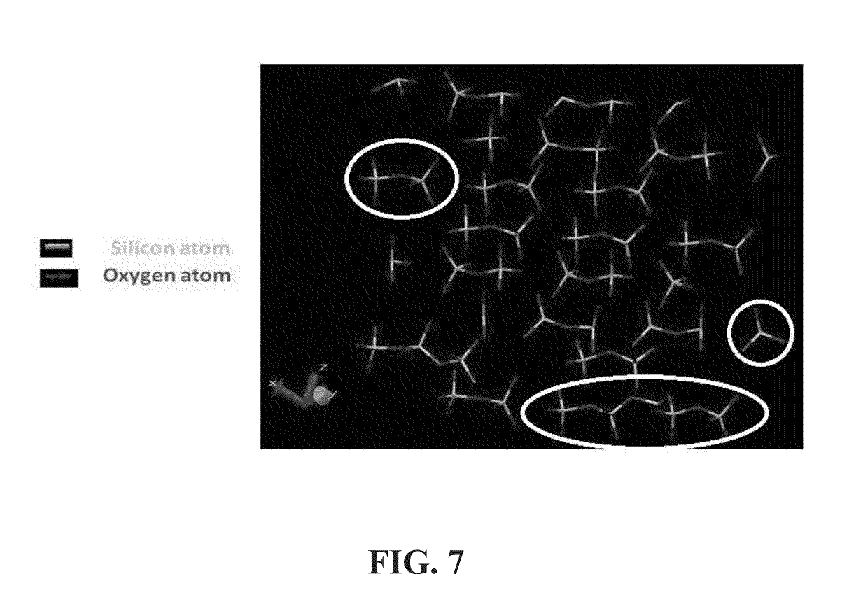

FIG. 7, which depicts only silicon and oxygen atoms, demonstrates that though the exemplary C-S-H of FIG. 4 comprises silicate chains of varying lengths (e.g., monomers (small circle) and pentamers (large oval)), a majority of the silicate chains that form the C-S-H are dimers (e.g., medium oval).

Without being bound by any theory, it is believed that the relatively ordered structure of the backbone depicted in FIGS. 4-7 enables a reduced interlayer distance (see e.g., FIG. 4) such that the overall structure exhibits increased density and reduced CaO and water content compared to that found in known C-S-H.

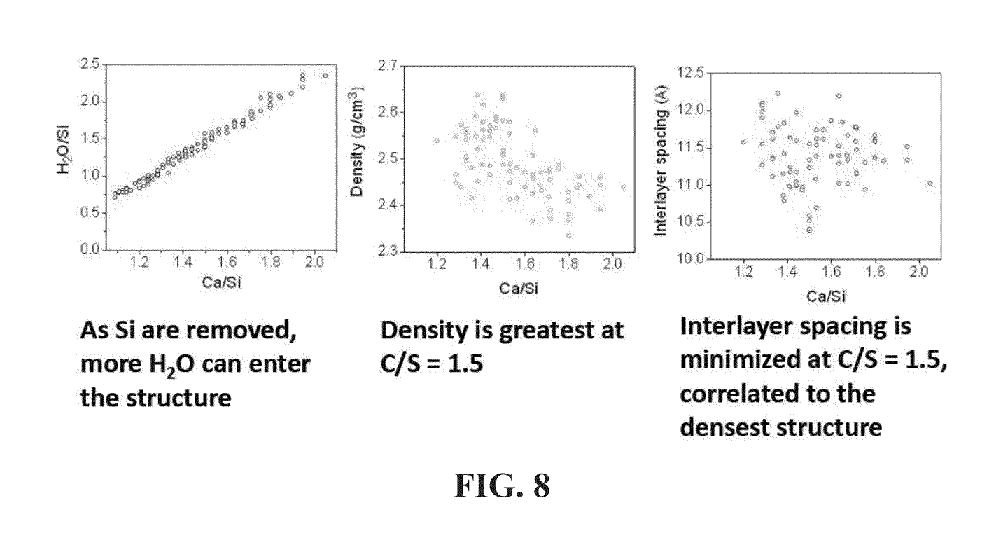

With reference now to FIG. 8, for example, the plots depict the simulated adsorption of H₂O into the C-S-H matrix as well as the theoretical density and interlayer distance for cement pastes produced using different combinations of clinker compositions and hydration conditions, and in the presence of various additives (e.g., NaOH and Na₂SiO₂). As shown in FIG. 8, the data demonstrates that as the Ca/Si ratio increases throughout the depicted range, more water (H₂O/Si) can enter the structure. The density of C-S-H is maximized (and the interlayer spacing is minimized), however, at a Ca/Si ratio of ˜1.5.

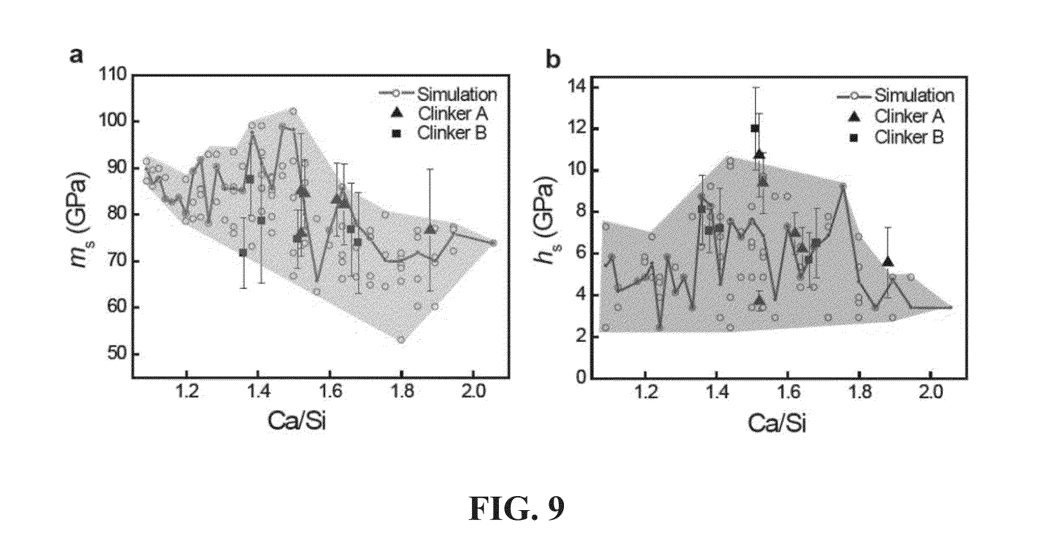

With reference now to FIG. 9, the plots depict the predicted values for indentation elastic modulus, mₛ=E/(1−v²), and hardness, hₛ (extracted from shear stress simulations) using the same exemplary atomistic simulations depicted in FIG. 8. As shown in FIG. 9, the simulation data (open circles) indicates a peak of indentation elastic modulus at about 1.5.

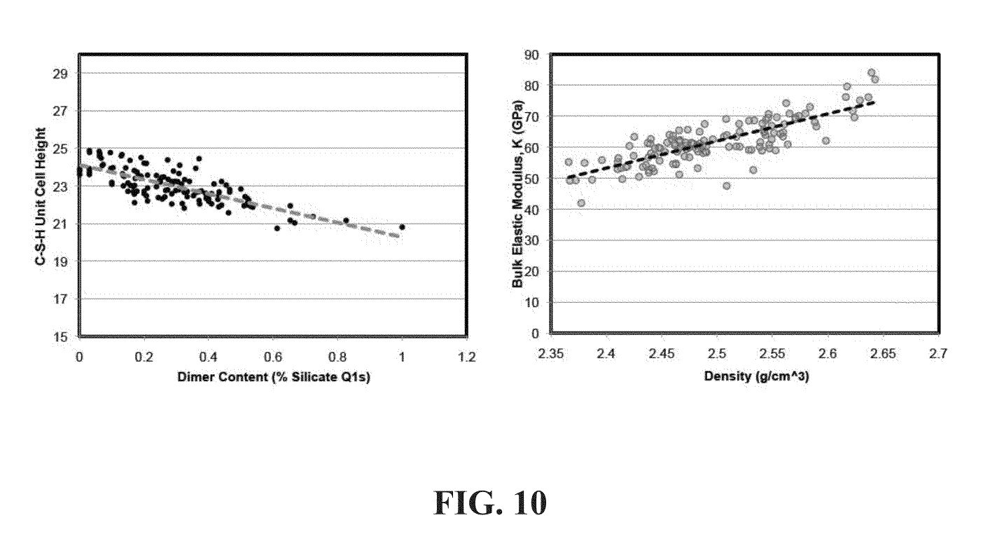

With reference now to FIG. 10, the simulated data further demonstrate that as the percentage of dimers increases (as determined, for example, based on the Qi NMR signal generated by the dimer silicate chains), the C-S-H unit cell height decreases, which in various aspects can result in a C-S-H density greater than 2.6 g/cm³ (e.g., greater than about 2.61 g/cm³, about 2.65 g/cm³).

It will further be appreciated that the various material properties of the C-S-H can be affected by the decreased interlayer distance and/or increased density. By way of example, as shown in the plot of FIG. 10, the bulk elastic modulus tends to increase with an increasing density of the C-S-H. Similar improvements are likewise predicted for the indentation elastic modulus and hardness of C-S-H in accordance with the present teachings. For example, the C-S-H of FIGS. 4-7 was calculated to have an indentation modulus, a parameter used to measure material stiffness under a compressive load, of 102 GPa, a 56% increase over the 65 GPa exhibited by conventional C-S-H. Indeed, the exemplary compositions and structures described herein can result in C-S-H exhibiting substantially improved mechanical proprieties relative to cement hydrates known in the art. By way of non-limiting example, C-S-H in accordance with the present teachings can exhibit improved Young's modulus, bulk modulus, shear modulus, indentation modulus, strength, and hardness.

### Examples

In order to experimentally obtain the simulated C-S-H compositions and structures discussed above, the clinker phase chemistry and dissolution conditions were systematically varied and characterized through Wavelength Dispersive X-ray Spectrometry. In an exemplary experiment, the Ca/Si ratios were varied using different clinker compositions, w/c ratios, and the additions of either NaOH or Na2SiO3, as follows:

| | Water-Cement | |
|---|---|---|
| Sample | Ratio (w/c) | Additives |
| A1 | 0.4 | |
| A2 | 0.3 | |
| A3 | 0.4 | NaOH |
| A4 | 0.4 | Na₂SiO₃ |
| A5 | 0.5 | NaOH |
| A6 | 0.5 | Na₂SiO₃ |
| B1 | 0.3 | |
| B2 | 0.4 | |
| B3 | 0.4 | NaOH |
| B4 | 0.4 | Na₂SiO₃ |
| B5 | 0.5 | NaOH |
| B6 | 0.5 | Na₂SiO₃ |

After producing a variety of cement pastes by varying the cement chemistry as described in the above table, the samples were tested to determine their chemical (e.g., Ca/Si ratio) and mechanical results (e.g., elastic indentation modulus (mₛ) and hardness (hₛ)), as follows:

| Sample | Ca/Si | mₛ(GPa) | hₛ (GPa) |
|---|---|---|---|
| A1 | 1.62 | 75.7 | 6.0 |
| A2 | 1.88 | 68.1 | 4.4 |
| A3 | 1.64 | 78.5 | 5.8 |
| A4 | 1.53 | 83.6 | 9.1 |
| A5 | 1.52 | 76.4 | 10 |
| A6 | 1.52 | 76.3 | 3.9 |
| B1 | 1.66 | 73.3 | 5.2 |
| B2 | 1.68 | 69.3 | 5.8 |
| B3 | 1.36 | 70.5 | 7.5 |
| B4 | 1.41 | 76.4 | 6.5 |
| B5 | 1.51 | 77.1 | 12 |
| B6 | 1.38 | 87.9 | 7.0 |

With reference again to FIG. 9, the simulation and experimental data exhibit similar trends for elastic indentation modulus (mₛ), though experimental results indicate a peak hardness (hₛ) at a Ca/Si of about 1.5 that is not predicted in the atomistic simulation. Nanoindentation experimental measurements, for example, indicate an increase of more than 25% in indentation modulus when the Ca/Si ratio decreases from 1.88 to about 1.5, even in the presence of common impurities in Portland cement such as Aluminum (Al), Magnesium (Mg), Iron (Fe), Sodium (Na), Potassium (K), Sulfur (S), Phosphorus (P).

All publication and references cited herein are likewise incorporated in their entireties by reference. The section headings used herein are for organizational purposes only and are not to be construed as limiting. While the applicants' teachings are described in conjunction with various embodiments, it is not intended that the applicants' teachings be limited to such embodiments. On the contrary, the applicants' teachings encompass various alternatives, modifications, and equivalents, as will be appreciated by those of skill in the art.

What is claimed is:

1. A cementitious composition having enhanced stiffness or strength, comprising:
a solid-state cement hydrate including a plurality of silicate chains, the plurality of silicate chains including a plurality of dimers constituting at least about 60% of the plurality of silicate chains present in the solid-state cement hydrate, the plurality of dimers enhancing the stiffness or strength of the solid-state cement hydrate.

2. The composition of claim 1, wherein the solid-state cement hydrate exhibits a periodic molecular structure formed from the plurality of silicate chains.

3. The composition of claim 2, wherein the periodic molecular structure comprises a ring-like structure in a plane substantially perpendicular to a Wollastonite layer of the solid-state cement hydrate.

4. The composition of claim 1, wherein the plurality of dimers constitute at least about 80% of the plurality of silicate chains.

5. The composition of claim 1, wherein the solid-state cement hydrate exhibits a CaO to SiO₂ ratio between about 1.4 and about 1.6.

6. The composition of claim 1, wherein the solid-state cement hydrate exhibits a density greater than 2.61 g/cm³.

7. A concrete material comprising the cementitious composition of claim 1.

8. A cementitious composition having enhanced stiffness or strength, comprising:
a solid-state cement hydrate including a plurality of silicate chains, the solid-state cement hydrate exhibiting a periodic molecular structure formed from the plurality of silicate chains, the periodic molecular structure enhancing the strength of the solid-state cement hydrate.

9. The composition of claim 8, wherein the plurality of silicate chains include a plurality of dimers.

10. The composition of claim 8, wherein the periodic molecular structure comprises a ring-like structure in a plane substantially perpendicular to a Wollastonite layer of the solid-state cement hydrate.

11. The composition of claim 8, wherein the solid-state cement hydrate exhibits a CaO to SiO₂ ratio between about 1.4 and about 1.6.

12. The composition of claim 8, wherein the solid-state cement hydrate exhibits a density greater than 2.61 g/cm³.

13. A concrete material comprising the cementitious composition of claim 8.

14. A cementitious composition having enhanced strength, comprising:
a solid-state cement hydrate including a plurality of silicate chains, the solid state cement hydrate exhibiting a CaO to SiO₂ ratio between about 1.4 and about 1.6 and predominantly dimer silicate chains.

15. A cement with a reduced calcium content suitable for use in forming a solid hydrate such that upon hardening into the hydrate, the hydrate exhibiting a CaO to SiO₂ ratio between about 1.4 and about 1.6 and predominantly dimer silicate chains.

16. A cement with a reduced calcium content suitable for use in forming a solid hydrate such that upon hardening into the hydrate, the hydrate exhibiting a silicate chain structure that constitutes at least about 60%, or 70% or 80% or 90% or 95% dimers.
